(19) United States
(12) Patent Application Publication
(10) Pub. No.: US 2017/0180397 A1
(43) Pub. Date: Jun. 22, 2017

(54) Thin Client Unit apparatus to transport intra-vehicular data on a communication network

(71) Applicants: Shivinder Singh Sikand, Santa Cruz, CA (US); Sam Appleton, Austin, TX (US); Dean Drako, Austin, TX (US)

(72) Inventors: Shivinder Singh Sikand, Santa Cruz, CA (US); Sam Appleton, Austin, TX (US); Dean Drako, Austin, TX (US)

(21) Appl. No.: 14/975,862

(22) Filed: Dec. 21, 2015

(51) Int. Cl. H04L 29/06

(52) U.S. Cl. CPC H04L 63/1416; H04L 63/126

(57) ABSTRACT

A vehicular data tunnel Thin Client Unit (TCU) apparatus includes a circuit to couple onto an Internet Protocol (IP) secure Ethernet transitory data communication medium. A circuit can transform and reverse serial data frames into and out of Internet Protocol packets including an encrypted IP packet. It includes a circuit to dispose of CAN data frames which are inconsistent with any mission of locally attached CAN or LIN compatible devices. The method of operation includes: receiving and dynamically installing configuration data to connect to an Ethernet medium as a terminus or as a relay in a ring, subscribe to a Intranet Vehicle Private Network, determine Quality of Service priority and recipient identification, receive and transform LIN and CAN data frames to IP packets, encrypt and decrypt packets for transmission, and conduct sender verification and data frame consistency.

### CROSS-REFERENCES TO RELATED APPLICATIONS

None.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Technical Field

The field of the invention is protection of sensor and control signals within a vehicle.

Description of the Related Art

It is known that Controller Area Network (CAN) busses, as widely deployed in conventional motor vehicles, are vulnerable. Conventional CAN messages are transported over an unsecured bus. Any CAN device can and does transmit to every other device. All devices can observe every message generated by all other clients. A CAN bus network is a distributed set of microcontrollers communicating over a common bus. All nodes observe all messages and may transmit any message to every other node. Each node must determine for itself which messages to accept. Bad behavior impinges on every node and is difficult to trace to an originator.

CAN is a multi-master serial bus standard for connecting Electronic Control Units [ECUs] also known as nodes. Two or more nodes are required on the CAN network to communicate. The complexity of the node can range from a simple I/O device up to an embedded computer with a CAN interface and sophisticated software. The node may also be a gateway allowing a standard computer to communicate over a USB or Ethernet port to the devices on a CAN network.

All nodes are connected to each other through a two wire bus. Each node is able to send and receive messages, but not simultaneously. A message or Frame consists primarily of the ID (identifier), which represents the priority of the message, and up to eight data bytes. A CRC, acknowledge slot [ACK] and other overhead are also part of the message. The improved CAN FD extends the length of the data section to up to 64 bytes per frame. The message is transmitted serially onto the bus using a non-return-to-zero (NRZ) format and may be received by all nodes.

The devices that are connected by a CAN network are typically sensors, actuators, and other control devices. These devices are connected to the bus through a host processor, a CAN controller, and a CAN transceiver.

CAN is a low-level protocol, and does not support any security features intrinsically. Applications are expected to deploy their own security mechanisms; e.g., to authenticate each other. Failure to do so may result in various sorts of attacks, if the opponent manages to insert messages on the bus. Password mechanisms exist for data transfer that can modify the control unit software, like software download or ignition key codes, but usually not for standard communication.

Ethernet, as defined in IEEE 802.3, is non-deterministic and thus it is unsuitable for hard real-time applications. The media access control protocol, CSMA/CD with its truncated binary exponential backoff algorithm, does not allow the network to support hard real-time (RT) communication as it incorporates random delays and allows for the possibility of transmission failure. But industrial extensions to the base standard enables RT systems whose correct execution depends not solely on the logical validity of data but also on its timeliness. A correct RT system will guarantee the successful operation of a system—so far as its timely execution is concerned. These extensions are commercially available.

What is needed is an improved apparatus and method to protect vehicle subsystems and their data from malicious or malfunctioning CAN devices, observers, or intruders.

### BRIEF SUMMARY OF THE INVENTION

The problem being solved is the well-known vulnerability of Controller Area Network (CAN) buses. A Thin Client Unit (TCU) interfaces one or more CAN devices into the secure, Ethernet-based backplane of the DriveOS platform. In an initial embodiment, the TCU acts as a kind of super Domain controller, but depending on cost, the TCU will start to adopt more of a “distributed endpoint” model. In an embodiment, the TCU provides a master MCU type attached to all device subsystems without an intervening CAN device.

The TCU takes CAN/LIN communications, which are fundamentally not secure (due to shared bus) and error-prone (due to shared bus communication), and encapsulates them for transport over a high-performance, non-shared Ethernet ring using extended Ethernet-compatible technologies.

The TCU architecture is critical because there will be 10s to 100s of TCUs in a car platform eventually. So the TCU must be both adequately powered (computationally) as well as cheap (to mirror the current cost range of an MCU that it takes the place of). Initially, an embodiment uses a combination of FPGA and standalone MCU (e.g. ATMEL ARM) to implement the TCU control plane. Ultimately, these technologies can be encapsulated in a dedicated ASIC to reduce cost to the current price range of the MCU, with embedded networking enabled.

A Thin Client Unit (TCU) includes the following components:

A. A dynamically configurable circuit to couple onto an Internet Protocol (IP) secure Ethernet transitory data communication medium as a terminus or as a relay in a ring. Both at startup and in production, the TCU may receive instructions to reconfigure itself. This may support avoidance of physical faults or loss of control at another TCU.

B. A circuit to determine a Quality of Service (QoS) priority for transforming and transmitting data frames and Internet Protocol packets. Based on the type and sender of data, an IP packet can receive a QoS attribute for handling and transmission.

C. A circuit to determine source and destination IP addresses associated with CAN identification fields and vice versa. The TCU is adapted to transform the clever coding of the identification fields of the data frames created by conventional CAN devices.

D. A circuit to transform and reverse serial data frames into and out of Internet Protocol packets. Priority and destinations are determined before packaging the payload of each data frame.

E. A circuit to transform a data frame into and out of an encrypted IP packet. The contents of the data frame are encrypted for transmission and the contents of received IP packets are decrypted.

F. A circuit to dispose of CAN data frames which are inconsistent with any mission of locally attached CAN or LIN compatible devices. A TCU drops data frames which are simply wrong or inconsistent with the type of devices to which it is appropriately attached.

G. A circuit to transmit packets upon sender verification and data frame sanity checks. A TCU ensures that data it transmits is coming from its legitimately attached devices.

The method of operation of a Thin Client Unit apparatus includes among other processes: receiving and dynamically installing configuration data to connect to an Ethernet medium as a terminus or as a relay in a ring, subscribing to a Intranet Vehicle Private Network, determining Quality of Service priority and recipient identification, receiving and transforming LIN and CAN data frames to IP packets, encrypting and decrypting packets for transmission, and conducting sender verification and data frame consistency.

In short, a vehicular data tunnel Thin Client Unit (TCU) apparatus includes a circuit to couple onto an Internet Protocol (IP) secure Ethernet transitory data communication medium. A circuit can transform and reverse serial data frames into and out of Internet Protocol packets including an encrypted IP packet. It includes a circuit to dispose of CAN data frames which are inconsistent with any mission of locally attached appropriate CAN or LIN compatible devices. The method of operation includes: receiving and dynamically installing configuration data to connect to an Ethernet medium as a terminus or as a relay in a ring, subscribe to a Intranet Vehicle Private Network, determine Quality of Service priority and recipient identification, receive and transform LIN and CAN data frames to IP packets, encrypt and decrypt packets for transmission, and conduct sender verification and data frame consistency.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a system;

FIGS. 2-7 are block diagrams of components of the system;

FIG. 8 A and B is a flowchart of processes in a method of operation of the components of apparatuses of the system.

### DETAILED DISCLOSURE OF EMBODIMENTS OF THE INVENTION

A vehicular data tunnel Thin Client Unit (TCU) apparatus includes a circuit to couple onto an Internet Protocol (IP) secure Ethernet-compatible transitory data communication medium.

A circuit can transform and reverse serial data frames into and out of Internet Protocol packets including an encrypted IP packet.

It includes a circuit to dispose of CAN data frames which are inconsistent with appropriate functionality of locally attached CAN or LIN compatible devices.

The method of operation includes: receiving and dynamically installing configuration data to connect to an Ethernet medium as a terminus or as a relay in a ring, subscribe to a Intranet Vehicle Private Network, determine Quality of Service priority and recipient identification, receive and transform LIN and CAN data frames to IP packets, encrypt and decrypt packets for transmission, and conduct sender verification and data frame consistency.

One aspect of the invention is a data Thin Client Unit (TCU) apparatus that has a dynamically configurable circuit to couple onto an Internet Protocol (IP) secure Ethernet transitory data communication medium as a terminus or as a relay in a ring; a circuit to transform and reverse serial data frames into and out of Internet Protocol packets; a circuit to transform a data frame into and out of an encrypted IP packet; and a circuit to determine a Quality of Service priority for transforming and transmitting data frames and Internet Protocol packets.

In an embodiment, the TCU also includes: a circuit to determine source and destination IP addresses associated with CAN identification fields and vice versa.

In an embodiment, the TCU also includes: a circuit to dispose of CAN data frames which are inconsistent with any mission of locally attached CAN or LIN compatible devices.

In an embodiment, the TCU also includes: a circuit to transmit packets upon sender verification and data frame sanity checks.

In an embodiment, said circuits are tangibly enabled by communicatively coupled: a micro-coded controller unit, an IP networking subsystem, a CAN/LIN data frame management and access control subsystem, and a payload transformation subsystem.

In an embodiment, the payload transformation subsystem includes: a circuit to determine recipient identity, Quality of Service priority, and content; a circuit to transform a CAN/LIN data frame into an encrypted IP packet for transmission via the Ethernet.

In an embodiment, the payload transformation subsystem also includes: a circuit to decrypt an encrypted IP packet, a circuit to determine a CAN/LIN data frame from the decrypted packet, and a circuit to transfer it to the CAN/LIN access control subsystem for delivery.

In an embodiment, the CAN/LIN data frame management and access control subsystem comprises: LIN PHY, CAN PHY, CAN MAC and buffers, and CAN hardware filtering and analysis circuits.

In an embodiment, the IP networking subsystem includes: L2 forwarding circuit coupled to each of two Ethernet MAC and RT coupled to their respective PHY and to an IP routing circuit; the IP routing circuit coupled to IP Buffers and control circuits for IP ingress and IP egress packets; a slave clock, and HMAC IP signal generator.

In an embodiment, the micro-coded controller unit includes a non-transitory store of legacy subsystem firmware coupled to an ARM MCU.

Another aspect of the invention is a method of operation of a data Thin Client Unit apparatus including the following steps: receiving configuration data to connect to an Ethernet medium; dynamically installing configuration data to reconnect to an Ethernet medium as one of a terminus and a relay in a ring; and subscribing to a Intranet Vehicle Private Network.

In an embodiment, the method also includes: reading data frame identification fields; and determining a Quality of Service priority and recipient address.

In an embodiment, the method also includes: receiving LIN and CAN data frames; and transforming data frames to IP packets.

In an embodiment, the method also includes: decrypting packets for CAN and LIN recipients; and encrypting packets for transmission on the IVPN.

In an embodiment, the method also includes: conducting sender verification and data frame consistency; and transmitting packets on the IVPN.

Unlike conventional CAN bus devices, TCUs do not naively accept messages directly received from another TCU unless explicitly enabled and in addition, particularly verified. Inspection, rejection, dropping, and encapsulation of messages which fail intrusion or quality tests are tasks explicitly assignable to TCU's in a ring configuration.

A CAN layer immediately next to a CAN device intercepts and qualifies all CAN messages generated by a single device or a domain of CAN devices. CAN messages are source tagged for filtering. Only message formats suitable for the known device may cross the layer. Thus taillight circuits cannot emit control signals coded for wipers. Entertainment circuits cannot emit control signals toward doors, windows, or sunroofs.

Each TCU has at least two Ethernet Phy circuits which may be configurable to transmit, receive, or both. Configured as a ring in normal geometry, each TCU receives packets on one Phy and transmits packets on the other. Packets may terminate or emit from a VCU coupled between two TCU. Each TCU also couples at least one CAN device through a CAN Phy. Each exposed CAN bus is limited in size to a single device or to a set of devices in a domain well known to each particular TCU. Malfunction or mis-behaving/hijacked devices can only affect their local CAN bus. Behavior outside the appropriate device profile is isolated from other clients and the VCU. For diagnostic purposes, inappropriate data frames may be encapsulated and transmitted to the VCU for fault and error diagnosis without risk of escaping into the Ethernet medium “in the wild”.

Each TCU has a hardware ID circuit used at initialization to obtain IP addresses and network assignment. An FPGA supported by flash memory for its image provides network control including DHCP, clocking, and encapsulation/decapsulation of the device instructions or measurements. A micro-controller and its flash memory supports a real time operating system and applications to support the functionality of the CAN subsystem compatible with conventional CAN controllers. The micro-controller inspects packets and filters CAN packets before encapsulation within an IP packet. Preventing intrusion or defects is primarily performed here before entering the secure Ethernet.

The CAN messages are encrypted for the destination, generally the VCU but in some cases certain TCU. Encryption/decryption is performed by the FPGA logic.

The TCU FPGA uses the hardware id chip to program MAC addresses, and the micro-controller initiates the DHCP client request for IP and VLAN assignment.

Once a TCU receives a VLAN assignment, it may broadcast to any other TCU within the same VLAN and to the VCU. However, if the VCU only assigns one TCU to a VLAN, then the VCU is the only recipient and subsequently decodes , verifies, reroutes and reencapsulates the data gram to another VLAN, most likely to a unique TCU recipient. Whether on not the TCU can transmit directly to other TCUs is within the control of the VCU when configuring VLAN addresses.

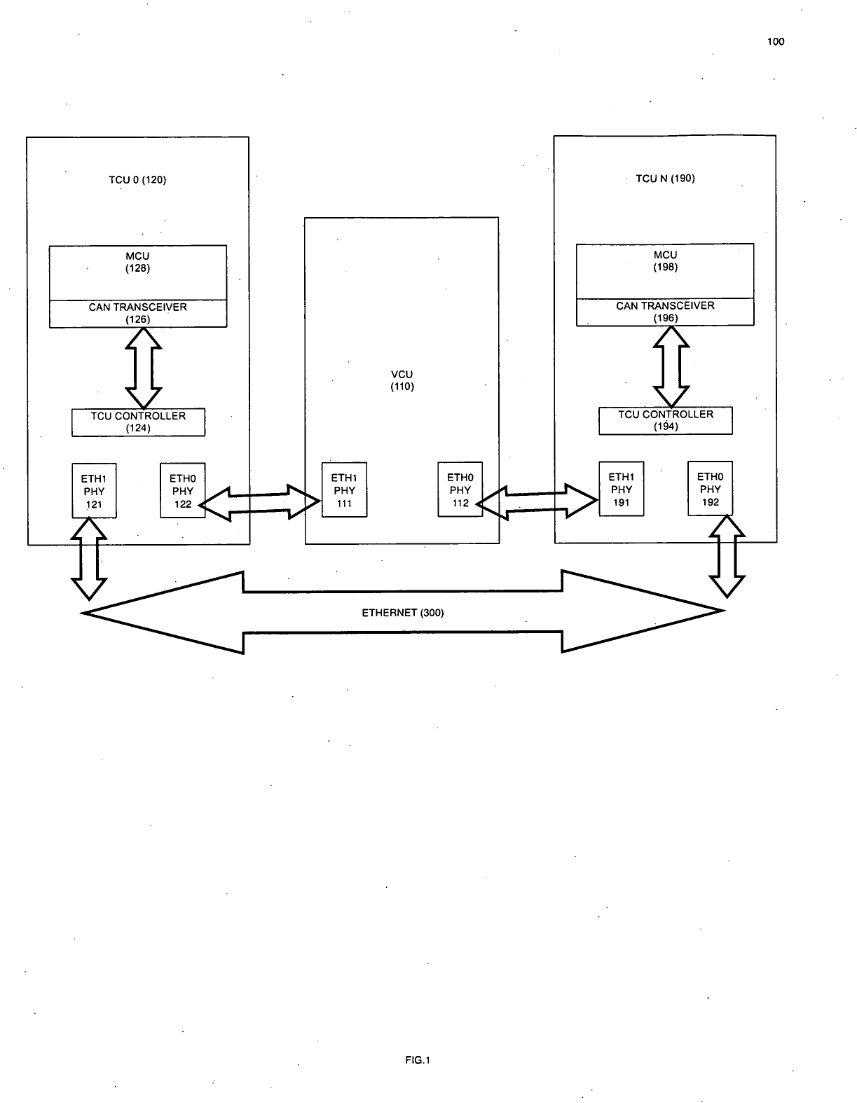

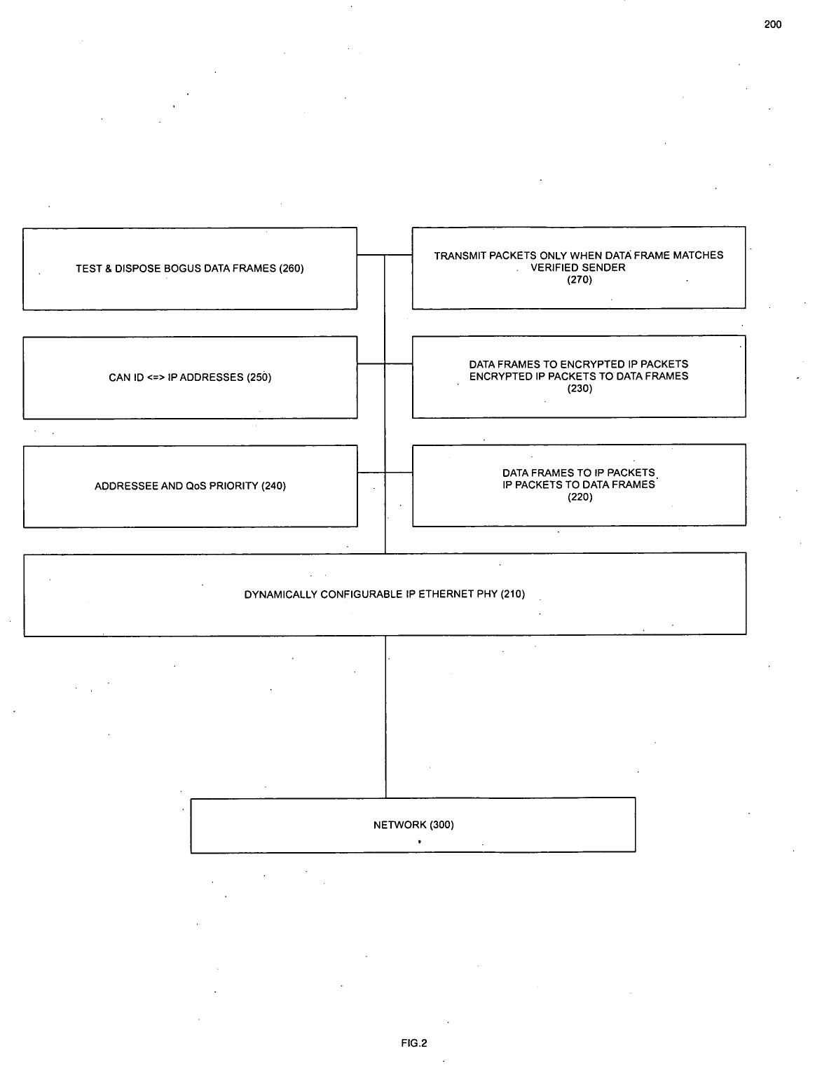

Referring to FIG. 1, a system 100 has a plurality of TCUs 120-190 coupled in a ring or spur with a VCU 110. A TCU may be taken off line or the media faulted to configure one or two spurs.

The VCU 110 has at least two Ethernet Phy 111-112

Each TCU has at least two Ethernet Phy 121- 122, 191-192.

Each TCU has a TCU controller 124, 194. The TCU controllers are coupled to CAN transceivers 126, 196 which are typically a component of the MCU 128, 198 controlling a vehicle subsystem.

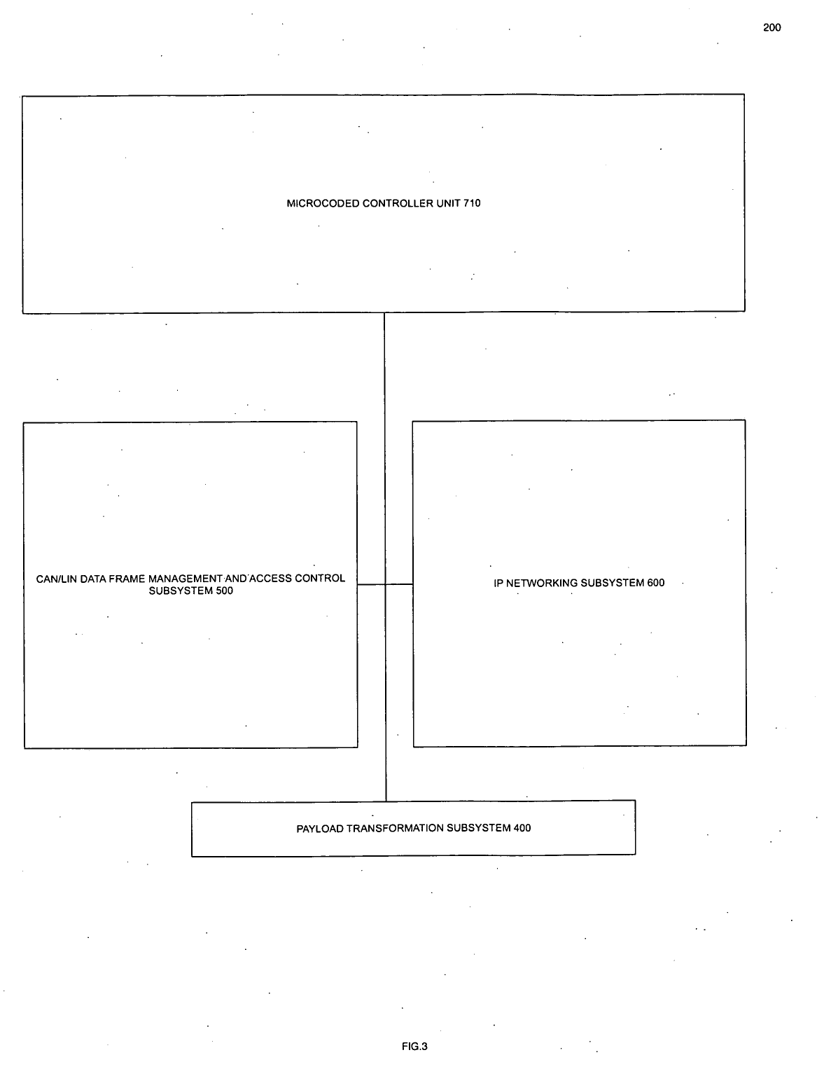

Referring now to the figures, in FIG. 2 is shown one aspect of the invention, a vehicular data tunnel Thin Client Unit (TCU) apparatus 200 which includes a dynamically configurable circuit 210 to couple onto an Internet Protocol (IP) secure Ethernet transitory data communication medium 300 as a terminus or as a relay in a ring; a circuit to transform and reverse serial data frames into and out of Internet Protocol packets 220; a circuit to transform a data frame into and out of an encrypted IP packet 230; and a circuit to determine a Quality of Service priority 240 for transforming and transmitting data frames and Internet Protocol packets.

In an embodiment, the apparatus also has a circuit to determine source and destination IP addresses 250 associated with CAN identification fields and vice versa.

In an embodiment, the apparatus also has a circuit to dispose of CAN data frames 260 which are inconsistent with any mission of locally attached CAN or LIN compatible devices.

In an embodiment, the apparatus also has a circuit to transmit packets 270 upon sender verification and data frame sanity checks.

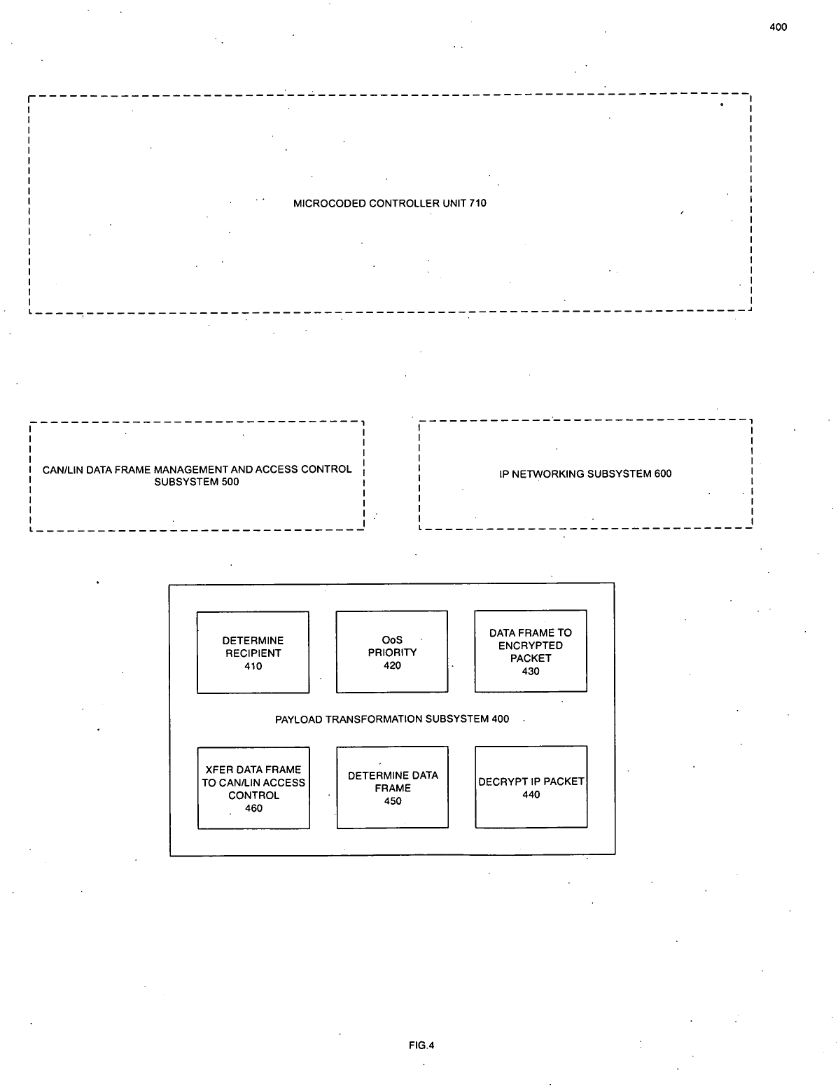

In an embodiment shown in FIG. 3, the above circuits of the apparatus include and are communicatively coupled to a microcoded controller unit 710, an IP networking subsystem 600, a CAN/LIN dataframe management and access control subsystem 500, and a payload transformation subsystem 400.

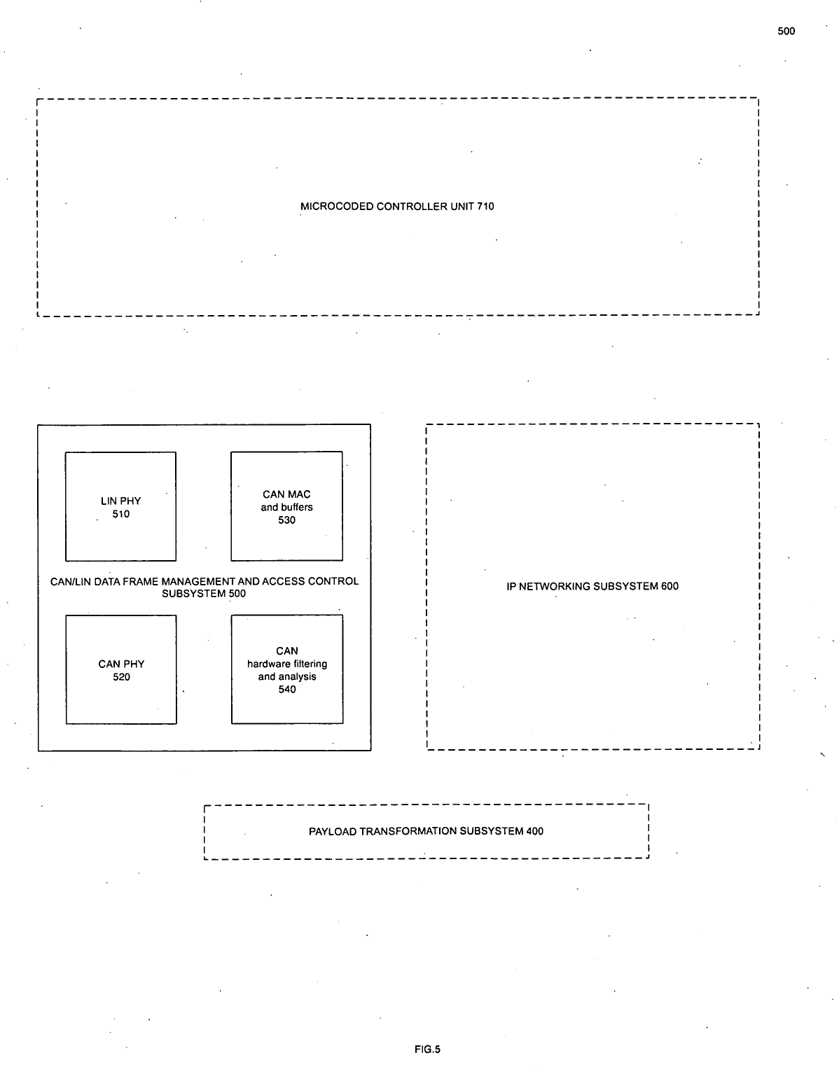

In an embodiment, the payload transformation subsystem 400 shown in FIG. 4 includes a circuit to determine recipient identity 410, Quality of Service priority, and content 420; and a circuit to transform a CAN/LIN data frame into an encrypted IP packet for transmission via the Ethernet 430.

In an embodiment, the payload transformation subsystem 400 also includes a circuit to decrypt an encrypted IP packet 440, a circuit to determine a CAN/LIN dataframe from the decrypted packet 450, and a circuit to transfer said dataframe to the CAN/LIN access control subsystem for delivery 460.

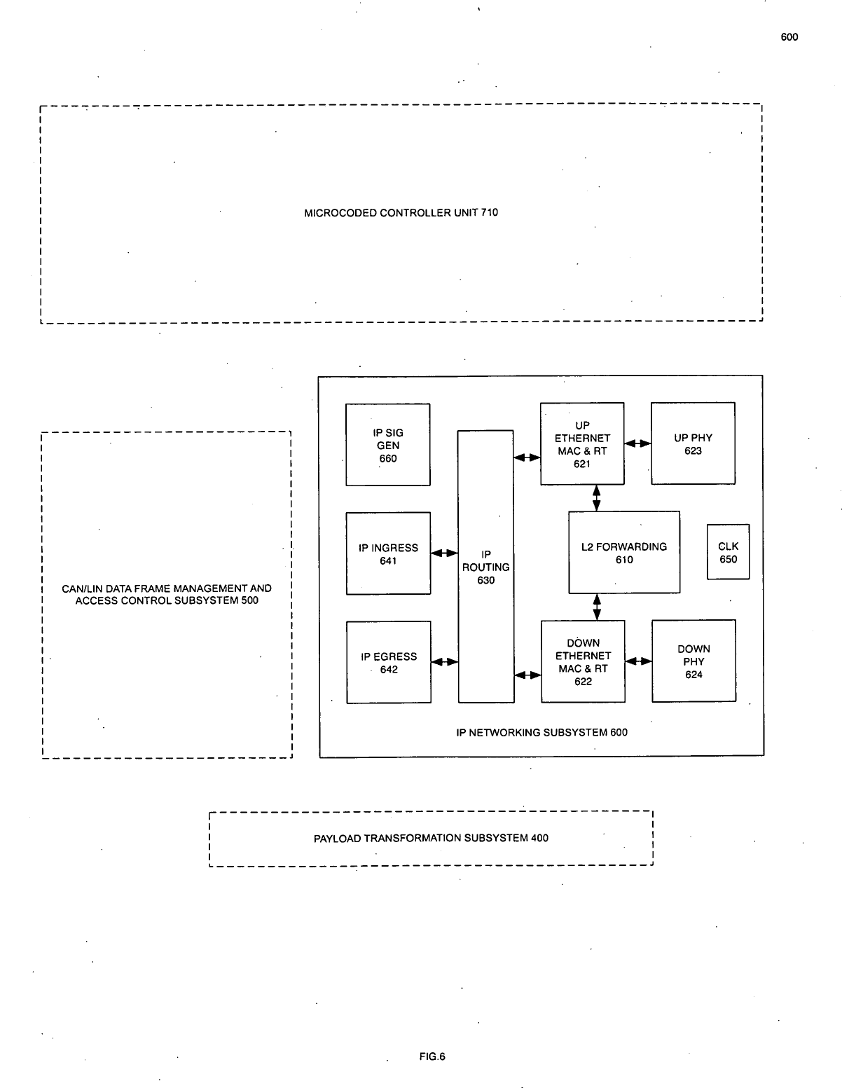

In an embodiment, the CAN/LIN dataframe management and access control subsystem 500 shown in FIG. 5 includes LIN PHY 510, CAN PHY 520, CAN MAC and buffers 530, and CAN hardware filtering and analysis circuits 540.

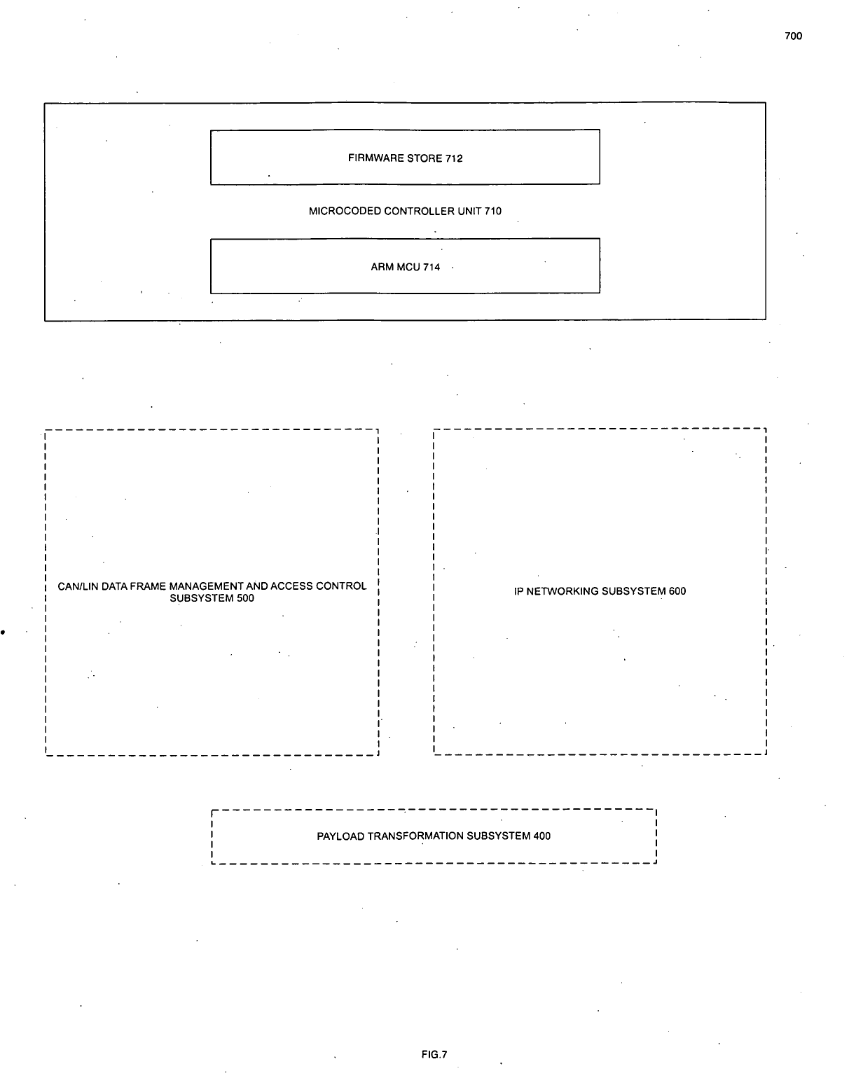

In an embodiment, the IP networking subsystem 600 shown in FIG. 6 also includes an L2 forwarding circuit 610 coupled to each of two Ethernet MAC and RT 621-622 coupled to their respective PHY 623-624 and to an IP routing circuit 630; the IP routing circuit coupled to IP Buffers 641-642 and control circuits for IP ingress and IP egress packets; a slave clock circuit 650; and an HMAC IP signal generator 660.

In an embodiment, the microcoded controller unit (MCU) 710 shown in FIG. 7 comprises a non-transitory store 712 of legacy subsystem firmware coupled to an ARM MCU 714 configured to perform the steps of the firmware.

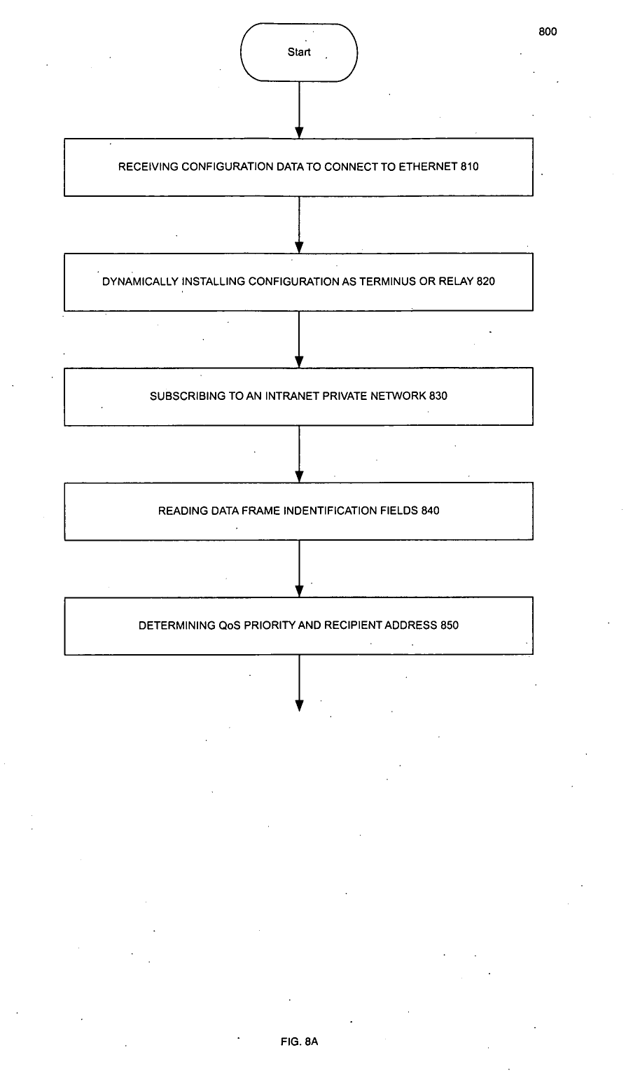

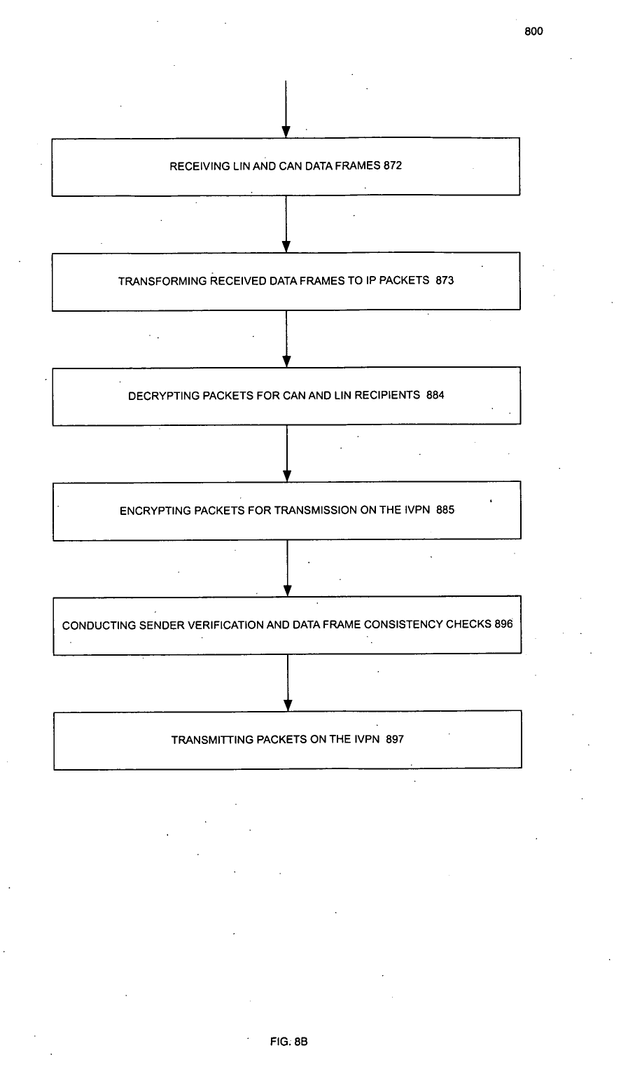

Another aspect of the invention shown in FIG. 8A is a method of operation 800 of a vehicular data tunnel Thin Client Unit apparatus including receiving configuration data to connect to an Ethernet medium 810; dynamically installing configuration data to reconnect to an Ethernet medium as one of a terminus and a relay in a ring 820; and subscribing to a Intranet Vehicle Private Network (IVPN) 830.

In an embodiment, the method also includes reading data frame identification fields 840; and determining a Quality of Service priority and recipient address 850.

In an embodiment shown in FIG. 8B, the method also includes receiving LIN and CAN data frames 872; and transforming said data frames to IP packets 873.

In an embodiment, the method also includes decrypting packets for CAN and LIN recipients 884; and encrypting packets for transmission on the IVPN 885.

In an embodiment, the method also includes conducting sender verification and data frame consistency 896; and transmitting packets on the IVPN 897.

It can be appreciated that the circuits may be implemented by processors using real time customized software closely coupled to each vehicle subsystem.

It is understood that circuits described above can be implemented as digital logic gates in a mask programmed standard cell or gate array. The circuits may equally be embodied in a programmable logic device depending on fuses or electrically erasable flash memory or firmware. The circuits may equally be embodied in Field Programmable Gate Arrays configured by non-transitory storage such as flash or read only memories (ROM). The circuits above may equally be embodied as processors adapted by instructions in non-transitory storage to perform the specific logic functions.

### CONCLUSION

The claimed apparatus, architecture, and system address a recently exposed vulnerability in the increasing intelligence of vehicle subsystems.

The claimed subject matter is easily distinguished from conventional vehicle communication buses which are already stressed by increasing volume and transmission rates. The claimed subject matter provides a private network for each vehicle subsystem that requires Quality of Service as well as security from spoofing or denial of service.

The claimed subject matter centralizes control over the communication channel and enables encryption and sender verification using a thin client suitable for deployment in lost cost high volume manufacturing. The architecture allows each vehicle subsystem to operate with immunity to faults in the data communication medium as well as faults in other vehicle subsystems. The architecture enables gradual phase out of CAN PHY circuits as newer vehicle subsystems become intelligent, economic, and secure.

The techniques described herein can be implemented in digital electronic circuitry, or in computer hardware, firmware, software, or in combinations of them. The techniques can be implemented as an embedded microcontroller, i.e., firmware tangibly embodied in a non-transitory medium, e.g., in a machine-readable storage device, for execution by, or to control the operation of circuit apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and connected by a wireless network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

### SEQUENCE LISTING

Not Applicable

We claim:

1. A vehicular data tunnel Thin Client Unit (TCU) apparatus comprises:
a dynamically configurable circuit to couple onto an Internet Protocol (IP) secure Ethernet transitory data communication medium as a terminus or as a relay in a ring;
a circuit to transform and reverse serial data frames into and out of Internet Protocol packets;
a circuit to transform a data frame into and out of an encrypted IP packet; and
a circuit to determine a Quality of Service priority for transforming and transmitting data frames and Internet Protocol packets.

2. The TCU apparatus of claim 1 further comprises:
a circuit to determine source and destination IP addresses associated with CAN identification fields and vice versa.

3. The TCU apparatus of claim 1 further comprises:
a circuit to dispose of CAN data frames which are inconsistent with any mission of locally attached CAN or LIN compatible devices.

4. The TCU apparatus of claim 1 further comprises:
a circuit to transmit packets upon sender verification and data frame sanity checks.

5. The TCU apparatus of claim 1 wherein said circuits are tangibly enabled by communicatively coupled:
a microcoded controller unit,
an IP networking subsystem,
a CAN/LIN dataframe management and access control subsystem, and
a payload transformation subsystem.

6. The TCU apparatus of claim 5 wherein the payload transformation subsystem comprises:
a circuit to determine recipient identity, Quality of Service priority, and content; and
a circuit to transform a CAN/LIN data frame into an encrypted IP packet for transmission via the Ethernet.

7. The TCU apparatus of claim 6 wherein the payload transformation subsystem further comprises:
a circuit to decrypt an encrypted IP packet,
a circuit to determine a CAN/LIN dataframe from the decrypted packet, and
a circuit to transfer said dataframe to the CAN/LIN access control subsystem for delivery.

8. The TCU apparatus of claim 5 wherein the CAN/LIN dataframe management and access control subsystem comprises:
LIN PHY,
CAN PHY,
CAN MAC and buffers, and
CAN hardware filtering and analysis circuits.

9. The TCU apparatus of claim 5 wherein the IP networking subsystem comprises:
L2 forwarding circuit coupled to each of two Ethernet MAC and RT coupled to their respective PHY and to an IP routing circuit;
the IP routing circuit coupled to IP Buffers and control circuits for IP ingress and IP egress packets;
a slave clock circuit; and
an HMAC IP signal generator.

10. The TCU apparatus of claim 5 wherein the microcoded controller unit comprises a non-transitory store of legacy subsystem firmware coupled to an ARM MCU configured to perform the steps of the firmware.

11. A method of operation of a vehicular data tunnel Thin Client Unit apparatus comprising:
receiving configuration data to connect to an Ethernet medium;
dynamically installing configuration data to reconnect to an Ethernet medium as one of a terminus and a relay in a ring; and
subscribing to a Intranet Vehicle Private Network(IVPN).

12. The method of claim 11 further comprising:
reading data frame identification fields; and
determining a Quality of Service priority and recipient address.

13. The method of claim 11 further comprising:
receiving LIN and CAN data frames; and
transforming said data frames to IP packets.

14. The method of claim 11 further comprising:
decrypting packets for CAN and LIN recipients; and
encrypting packets for transmission on the IVPN.

15. The method of claim 11 further comprising:
conducting sender verification and data frame consistency; and
transmitting packets on the IVPN.
